(19) United States
(12) Patent Application Publication
(10) Pub. No.: US 2008/0253407 A1
(43) Pub. Date: Oct. 16, 2008

(54) LASER AND METHOD FOR GENERATING PULSED LASER RADIATION

(75) Inventors: Guenter Hollemann, Jena (DE); Peter Heist, Jena (DE); Matthias Hoffmann, Jena (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: JENOPTIK LASER, OPTIK, SYSTEME GMBH, Jena (DE)

(21) Appl. No.: 12/101,676

(22) Filed: Apr. 11, 2008

(30) Foreign Application Priority Data
Apr. 13, 2007 (DE) 102007017591.6

(51) Int. Cl. H01S 3/117

(52) U.S. Cl. 372/13

(57) ABSTRACT

A laser for generating pulsed laser radiation is provided. The laser includes a resonator, a laser-active medium arranged in the resonator, and an acousto-optic modulator arranged in the resonator. The modulator can be put in a first and a second state so as to set the resonator quality, the resonator quality being lower in the first state than in the second state, and comprising a control unit for controlling the modulator. The control unit effects phase-locked coupling of a high-frequency signal to be applied to the modulator in one of said two states, in order to generate a predetermined sound field in the modulator, and a switching signal designed to switch the modulator periodically between the two states.

### RELATED APPLICATION

The current application claims the benefit of priority to German Patent Application No. 10 2007 017591.6 filed on Apr. 13, 2007. Said application is incorporated by reference herein.

### FIELD OF THE INVENTION

The present invention relates to a laser and a method for generating pulsed laser radiation.

### BACKGROUND OF THE INVENTION

For the purpose of generating pulsed laser radiation, a Q-switched regime is used in many cases, in which the resonator quality is switched periodically between low quality and high quality. For such quality switching, a modulator is provided in the resonator.

For example, the modulator may be provided as a Pockels cell, by which the polarization direction of the radiation in the resonator can be influenced by applying a high voltage and, thus, the desired Q-switching can be achieved. A Pockels cell allows to achieve very good pulse-to-pulse stabilities. However, complex control electronics are required for fast switching of the necessary high voltage (in the range of several kV) for the Pockels cell. These control electronics also lead to a relatively low reliability, especially in industrial applications.

If the modulator used is an acousto-optic modulator, a high-frequency small signal voltage will be sufficient to operate the modulator, which increases the reliability of the laser. However, there is a pulse-to-pulse variation in intensity and/or energy of up to 5%. Many applications, however, require pulse-to-pulse stabilities of intensity and energy of less than 1%.

### SUMMARY OF THE INVENTION

In view of the above, it is an object of the invention to provide a laser for generating pulsed laser radiation, said laser having a high reliability and a very low pulse-to-pulse stability of intensity and energy.

The object is achieved by a laser resonator for generating pulsed laser radiation, comprising a resonator, a laser-active medium arranged in the resonator, an acousto-optic modulator arranged in the resonator, which modulator can be put in a first and a second state so as to set the resonator quality, said resonator quality being lower in the first state than in the second state, and comprising a control unit for controlling the modulator, which control unit effects phase locked coupling of a high-frequency signal to be applied to the modulator in one of said two states, in order to generate a predetermined sound field in the modulator, and a switching signal designed to switch the modulator periodically between said two states.

The phase locked coupling of the high-frequency signal and the switching signal has the advantageous effect that the actual switching periods are stable in time, i.e., respectively have the same constant duration from one switching cycle to another, even if switching of the high-frequency signal takes place only at a zero point, as is common in acousto-optic modulators. This allows to achieve an excellent pulse-to-pulse stability.

In the laser, the switching signal may alternately comprise first switching edges, in order to switch the modulator from the second to the first state, and second switching edges, in order to switch the modulator from the first to the second state, with the control unit effecting phase-locked coupling of both the first switching edges and the second switching edges to the high-frequency signal. Thus, the periods of both states which are relevant for pulse generation are absolutely stable via the switching edges and there are no undesired pulse-to-pulse variations.

The control unit can derive both the high-frequency signal and the switching signal from one single reference signal having a predetermined reference frequency. Thus, the desired phase-locked coupling is easily achieved.

In particular, the reference signal can be generated by one single, highly stable frequency generator, so that only one frequency generator is required to generate the desired high-frequency signal as well as the switching signal.

The frequency generator may be, for example, the frequency generator which is usually provided in the control electronics of an acousto-optic modulator. It is also possible, of course, to use a separate frequency generator.

The reference frequency may correspond to the frequency of the high-frequency signal. In this case, no modification of the frequency for generating the high-frequency signal is necessary.

The reference frequency may also differ from the frequency of the high-frequency signal, in which case a suitable electronic circuit (frequency divider or multiplier=frequency converter) is provided to generate the high frequency needed for the modulator.

The reference frequency may also be divided or multiplied, respectively, by a frequency divider or multiplier to generate a high-frequency signal from which the switching signal is in turn obtained. The frequency divider or multiplier (switching reference signal) may be part of the laser.

The desired switching periods for the first and second states are freely selectable in each case. For example, the clock of the switching reference signal can be counted, in a manner of speaking, in order to determine the switching times of the switching signal (or the points in time of the switching edges of the switching signal, respectively) therefrom, in which case the smallest increment is then given by the reciprocal frequency of the switching reference signal or its period.

The laser may further comprise a pump light source which pumps the laser-active medium in continuous-wave operation. However, any other manner of pumping the laser-active medium is also possible.

The control unit may also perform particularly those functions which are necessary to operate the laser and which are presumably known to the person skilled in the art.

The laser-active medium may be, for example, a crystalline solid. Materials suitable for use are, e.g., Nd:YAG, Yb:YAG or Nd:YVO4.

The laser according to the invention can be operated with extremely low pulse-to-pulse variations of power and/or energy, even if the pulse repetition frequency is considerably greater than the reciprocal fluorescence lifetime of the upper laser level. Especially in this type of operation, there are usually great pulse-to-pulse variations, which are no longer present using the laser according to the invention. Thus, the laser, comprising Nd:YVO4 as the laser medium, can be operated with excellent pulse-to-pulse stability even at pulse repetition frequencies above 100 kHz. With Yb:YAG as the laser-active medium, stable operation is possible even at pulse repetition frequencies of greater than 10 kHz.

The laser according to the invention may be used, for example, in the Q-switched regime, in which the desired laser pulse is generated in the high-quality state. However, it is also possible to operate the laser according to the invention in the cavity-dumping regime wherein, in the high-quality state, no laser radiation is coupled out, but the resonator is operated as a closed resonator in order to build up a strong oscillation. In the low-quality state, the resonator is quickly depleted, so that the desired laser pulse is coupled out.

Typical pulse durations are in the ns to μs range; in particular, pulse durations from 10-1000 ns are generated.

Further, a method is provided for generating pulsed laser radiation in a laser, said laser comprising a resonator, a laser-active medium arranged in the resonator, an acousto-optic modulator arranged in the resonator, which modulator can be put into a first and a second state in order to set the resonator quality, said resonator quality being lower in the first state than in the second state, wherein in order to generate said pulsed laser radiation the modulator is switched periodically between both states, depending on a switching signal, and a predetermined high-frequency signal is applied to the modulator in one of the two states in order to generate a sound field in the modulator, said high-frequency signal and said switching signal being coupled to each other in a phase-locked manner.

Due to the phase-locked coupling of the high-frequency signal and the switching signal, undesired pulse-to-pulse variations are suppressed.

In the method, the switching signal may alternately comprise first switching edges, in order to switch the modulator from the second to the first state, and second switching edges, in order to switch the modulator from the first to the second state, with both the first switching edges and the second switching edges being coupled to the high-frequency signal in a phase locked manner.

Due to this phase-locked coupling, the actual switch-on and switch-off periods of the acousto-optic modulator can be implemented in an extremely stable manner, so that no pulse-to-pulse variations are induced.

In the method, both the high-frequency signal and the switching signal may be derived from one single reference signal having a predetermined reference frequency. In this manner, it is extremely easy to achieve the phase-locked coupling. In particular, only one single frequency generator needs to be provided in order to generate the required single reference signal in a manner stable over time.

In particular, the reference frequency may correspond to the frequency of the high-frequency signal. In this case, for example, the frequency generator which is usually contained in the control electronics of an acousto-optic modulator can be used as a frequency generator for generating the reference signal.

The reference frequency may also differ from the frequency of the high-frequency signal, in which case a frequency division or multiplication is carried out in order to generate the high-frequency signal for the modulator.

Further, the reference frequency may be divided or multiplied in order to generate a high-frequency signal (switching reference signal) from which, again, only the switching signal is obtained.

Thus, the switching periods for the first and second states are freely selectable in each case. If the switching period of the switching signal is determined by counting the clock of the switching reference signal, the smallest step duration (for the switching period) is given by the reciprocal frequency of the switching reference signal or its period, respectively.

The laser-active medium can be optically pumped in continuous-wave operation. However, any other type of pumping of the laser-active medium is also possible.

It will be appreciated that the aforementioned features and those to be explained below can be used not only in the indicated combinations, but also in other combinations or alone, without departing from the scope of the present invention.

### BRIEF DESCRIPTION OF THE DRAWINGS

The invention will be explained in more detail below, by way of example and with reference to the enclosed drawings, which disclose features essential to the invention and wherein:

FIG. 1 shows a schematic view of an embodiment of the laser according to the invention for generating pulsed laser radiation;

FIG. 2 shows a view explaining the phase-locked coupling of the switching signal to the high-frequency signal as well as the switch-on and switch-off times of the acousto-optic modulator;

FIG. 3 shows a schematic view of a further embodiment of the laser according to the invention; and

FIG. 4 shows a view explaining the pulse-to-pulse variations which appear in a conventional laser comprising an acousto-optic modulator.

### DETAILED DESCRIPTION

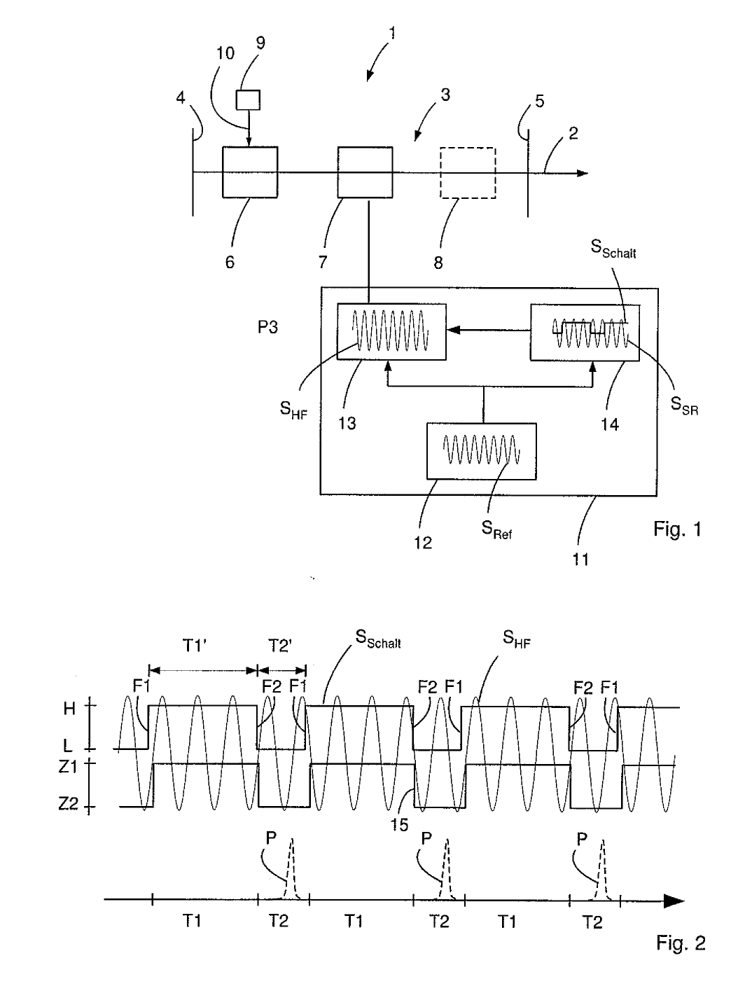

In the embodiment shown in FIG. 1, the laser I for generating pulsed laser radiation 2 comprises a resonator 3, which is formed here by a highly reflective end mirror 4 as well as by a coupling-out mirror 5.

A laser-active medium 6 (which is, for example, a crystalline solid) and an acousto-optic modulator 7 are arranged in the resonator 3. Optionally, a non-linear optical element 8 for frequency multiplication, for example, may further be arranged in the resonator 3. The element 8 is indicated here by a dashed line.

In order to pump the laser-active medium 6, a pump light source 9 (e.g., a diode laser) is provided, which pumps the laser-active medium 6 in continuous-wave operation, as indicated by the arrow 10.

The laser 1 further comprises a control unit 11, which includes a highly stable frequency generator 12, a high-frequency amplifier 13, as well as a switching edge generator 14.

The laser 1 is operated in the Q-switched regime by the acousto-optic modulator 7 in order to generate the desired laser pulses. For this purpose, the frequency generator 12 of the control unit 11 generates a reference signal S_{Ref} with a predetermined reference frequency f_{ref} of, for example, 30 MHz in the present case. The reference signal S_{Ref} is applied to both the high-frequency amplifier 13 and the switching edge generator 14, whereby, as will be described below, a high-frequency signal S_{HF} is generated in the high-frequency amplifier 13 and a switching reference signal S_{SR} is generated in the switching edge generator 14.

The high-frequency amplifier 13 amplifies the reference signal S_{Ref} and thus generates the desired high-frequency signal S_{HF} which, when applied to the acousto-optic modulator 7, causes a predetermined sound field to be generated in the modulator 7. In the exemplary embodiment described herein, once the high-frequency signal S_{HF} has been applied, the acousto-optic modulator couples out radiation from the resonator 3, so that the resonator quality is low. If no high-frequency signal S_{HF} is applied to the acousto-optic modulator 7, no radiation is coupled out so that the resonator quality is higher.

The switching-on and switching-off of the high-frequency signal S_{HF} applied to the acousto-optic modulator 7 may be effected, depending on the system (for technical/physical reasons), only at those times at which the voltage of the high-frequency signal S_{HF} is presently zero. Therefore, acousto-optic modulators are generally switched at a quite specific phase position, namely the so-called zero point.

The high-frequency signal S_{HF} is applied to the acousto-optic modulator 7 in a manner depending on the the switching signal S_{Schalt} generated in the switching edge generator 14 on the basis of the switching reference signal S_{SR}. When the switching signal S_{Schalt} changes from low (L) to high (H) (switch-on edge F1), as shown in FIG. 2, the high-frequency signal S_{HF} is applied to the acousto-optic modulator 7 at the next zero crossing of the high-frequency signal S_{HF}, so that the acousto-optic modulator 7 is in its first state Z1, in which the resonator quality is low. In this connection, FIG. 2 shows the actual time periods T1, T2, during which the high-frequency signal S_{HF} is applied (T1) and not applied (T2) to the modulator 7, as signal 15.

When the switching signal S_{Schalt} is switched to low (L) thereafter (switch-off edge F2), the high-frequency signal S_{HF} is not applied (any more) to the acousto-optic modulator 7 at the next zero crossing of the high-frequency signal S_{HF}, so that the resonator quality is higher (second state Z2 of the modulator 7), whereby a laser pulse P is then generated in a known manner, which pulse is indicated by a dashed line in FIG. 2.

Next, another switch-on edge F1 follows. The time period between a switch-on edge F1 and the subsequent switch-off edge F2 is T1′ and the time period between a switch-off edge F2 and the subsequent switch-on edge F1 is T2′. As indicated in FIG. 2, the time periods T1 and T2 of both states of the quality of the resonator 3 differ from the time periods T1′ and T2′. However, the time periods T1 and T2, as will be explained below, are the same from one switching cycle to another, so that the undesired pulse-to-pulse variations no longer occur.

The switching signal S_{Schalt} is generated on the basis of the periodic clock of the switching reference signal S_{SR}, which corresponds to that of the reference signal S_{Ref} here, the intervals (T1′ and T2′) between the switching edges F1, F2 of the switching signal S_{Schalt} being selected such that the desired pulse repetition frequency fᵣₑₚ is achieved. Here, the pulse repetition frequency is the reciprocal of the sum of the time periods T1 and T2 (FIG. 2) and is, depending on the laser type and the application, within the kiloHertz range (i.e. from 1 to several 100 kHz).

Since both the switching signal S_{Schalt} and the high-frequency signal S_{HF} are derived from the same reference signal S_{Ref}, the switching signal S_{Schalt} and the high-frequency signal S_{HF} are coupled to each other in a phase-locked manner.

This has the advantageous effect that the switch-on edges or first switching edges F1 and the switch-off edges or second switching edges F2 are also coupled to the high-frequency signal S_{HF} in a phase locked manner, so that the time periods T1 and T2 are extremely stable and no pulse-to-pulse variations occur. Although the time period T1′ is different from T1 and T2′ is different from T2, the phase locked coupling has the effect that T1 and T2 (i.e. the actual switching times) are always the same from one switching cycle to another. Even if the phase between the switching signal S_{Schalt} and the high-frequency signal S_{HF} should not be zero, which is assumed to be the case in FIG. 2, said phase is constant due to the phase locked coupling of the two signals, so that the switching edges F1 and F2 of the switching signal S_{Schalt} always switch the high-frequency signal S_{HF} at the same phase position.

Thus, the phase-locked coupling, according to one embodiment of the invention, of the switching signal S_{Schalt} and of the high-frequency signal S_{HF} leads to a minimization of the undesired time jitter, although, as already mentioned, a high-frequency amplifier 13 for acousto-optic modulators usually allows switching off or on only at a quite specific phase position of the high-frequency signal S_{HF} (preferably the zero crossing).

FIG. 4 indicates, in a similar manner as FIG. 2, the high-frequency signal S_{HF}, an applied switching signal S_{Schalt} with the time periods T3 and T4, as well as a signal 15′, which indicates the actual time periods of both states Z1 and Z2. However, it is assumed that the applied switching signal S_{Schalt}, as common so far in the prior art, is not coupled to the high-frequency signal S_{HF} in a phase-locked manner, because the switching signal S_{Schalt′} is derived from the reference signal of a separate frequency generator (not shown). This then has the effect that the switching edges of the switching signal S_{Schalt′} meet the high-frequency signal S_{HF} at different phase positions, so that the actual switching times of the modulator 7 are shifted and, thus, the time periods T5, T6, T7, T8 and T9, T10 vary from one pulse generation to another. This results in an undesired time jitter, which is, at maximum, as great as the period of the high-frequency signal S_{HF}. This time jitter may be minimized by the phase-locked coupling, according to the invention, of the high-frequency signal S_{HF} and of the switching signal S_{Schalt}.

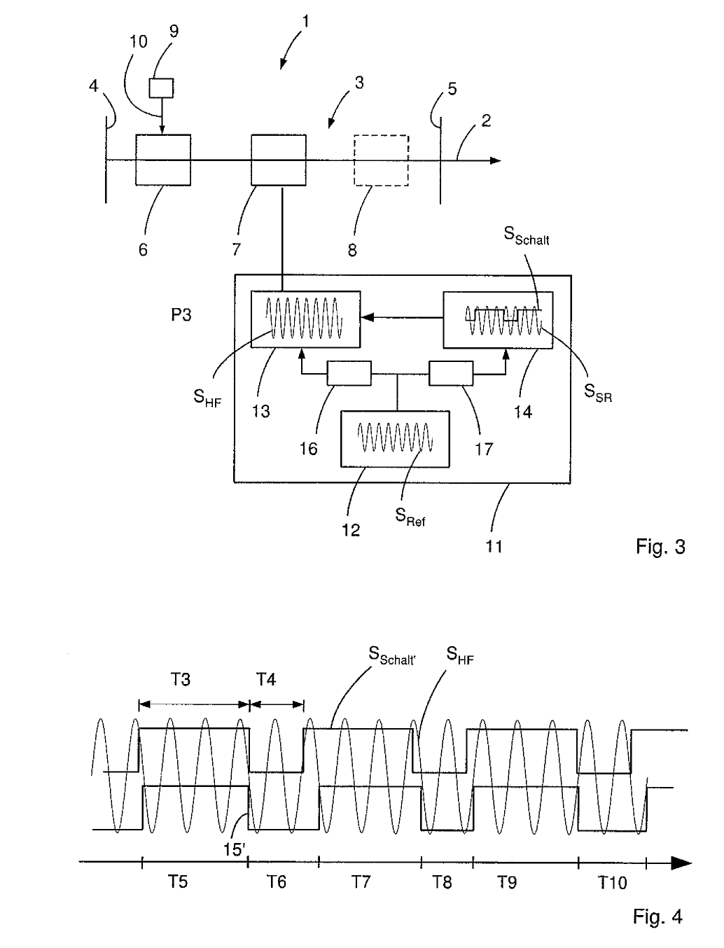

FIG. 3 shows a modification of the laser of FIG. 1, wherein the same elements are referred to by the same reference symbols, and for their description, reference is made to the above statements. In contrast to the embodiment of FIG. 1, the laser of FIG. 3 comprises a first frequency converter 16, between the frequency generator 12 and the high-frequency amplifier 13, and a second frequency converter 17 between the frequency generator 12 and the switching edge generator 14. This makes it possible for the frequency of the high-frequency signal S_{HF} as well as the frequency of the switching reference signal S_{SR} and, thus, of the switching signal S_{Schalt} to be selected independently of each other and differing from the frequency of the reference signal S_{Ref}. The two frequency converters 16, 17 can divide or multiply the frequency of the reference signal S_{Ref}.

In addition to the described Q-switched regime for generating the pulses, the laser according to the invention can also be operated in the so-called cavity-dumping regime. In this regime, switching is effected by the modulator 7 between a state of very high quality, which is characterized, for example, by almost 100% reflection of all resonator mirrors, and a state of very high coupling-out (low quality), in which high resonance losses occur. The coupled-out laser radiation forms the desired laser pulse.

1. A laser for generating pulsed laser radiation, said laser comprising
a resonator;
a laser-active medium arranged in the resonator;
an acousto-optic modulator arranged in the resonator, which modulator can be put in a first and a second state so as to set the resonator quality, said resonator quality being lower in the first state than in the second state; and
a control unit for controlling the modulator,
wherein the control unit effects phase-locked coupling of a high-frequency signal to be applied to the modulator in one of said two states, in order to generate a predetermined sound field in the modulator, and a switching signal designed to switch the modulator periodically between said two states.

2. The laser as claimed in claim 1, wherein the switching signal alternately has first switching edges, in order to switch the modulator from the second to the first state, and second switching edges, in order to switch the modulator from the first state to the second state, with the control unit coupling both the first switching edges and the second switching edges to the high-frequency signal in a phase locked manner.

3. The laser as claimed in claim 1, wherein the control unit derives both the high-frequency signal and the switching signal from one single reference signal having a predetermined reference frequency.

4. The laser as claimed in claim 3, further comprising a frequency generator which generates the reference signal.

5. The laser as claimed in claim 3, further comprising a first frequency converter which obtains the frequency of the high-frequency signal from the reference signal.

6. The laser as claimed in claim 3, further comprising a second frequency converter which obtains from the reference signal the frequency of a switching reference signal which is used to generate the switching signal.

7. The laser as claimed in claim 3, wherein the reference frequency corresponds to the frequency of the high-frequency signal.

8. The laser as claimed in claim 1, further comprising a pump light source, which pumps the laser-active medium in continuous-wave operation.

9. A method for generating pulsed laser radiation in a laser comprising a resonator, a laser-active medium arranged in the resonator, an acousto-optic modulator arranged in the resonator, which modulator can be put in a first and a second state in order to set the resonator quality, said resonator quality being lower in the first state than in the second state, wherein in order to generate said pulsed laser radiation the modulator is switched periodically between both states, depending on a switching signal, and a predetermined high-frequency signal is applied to the modulator in one of the two states in order to generate a sound field in the modulator,
said high-frequency signal and said switching signal being coupled to each other in a phase-locked manner.

10. The method as claimed in claim 9, wherein the switching signal alternately has first switching edges, in order to switch the modulator from the second to the first state, and second switching edges, in order to switch the modulator from the first state to the second state, with both the first switching edges and the second switching edges being coupled to the high-frequency signal in a phase locked manner.

11. The method as claimed in claim 9, wherein both the high-frequency signal and the switching signal are derived from one single reference signal having a predetermined reference frequency.

12. The method as claimed in claim 11, wherein the frequency of the high-frequency signal is derived from the reference signal by frequency conversion.

13. The method as claimed in claim 11, wherein the frequency of the switching signal is derived from the reference signal by frequency conversion.

14. The method as claimed in claim 9, wherein the laser-active medium is optically pumped in continuous-wave operation.

15. A method for generating pulsed laser radiation, comprising:
pumping a laser-active medium in a resonator of a laser;
operating an acousto-optic modulator of the resonator to produce a first resonation state;
generating a high-frequency signal and a switching signal, wherein the high-frequency signal and the switching signal are coupled to each other in a phase-locked manner;
applying the high-frequency signal to the acousto-optic modulator of the resonator to generate a sound field, thereby producing a second resonation state, wherein the quality of the second resonation state is lower than the quality of the first resonation state; and
periodically switching the modulator between the first and the second state in accordance with the switching signal to produce pulsed laser radiation.

16. The method as claimed in claim 15, wherein the switching signal alternately has first switching edges, in order to switch the modulator from the second to the first state, and second switching edges, in order to switch the modulator from the first state to the second state, with both the first switching edges and the second switching edges being coupled to the high-frequency signal in a phase-locked manner.

17. The method as claimed in claim 15, wherein both the high-frequency signal and the switching signal are derived from one single reference signal having a predetermined reference frequency.

18. The method as claimed in claim 17, wherein the frequency of the high-frequency signal is derived from the reference signal by frequency conversion.

19. The method as claimed in claim 17, wherein the frequency of the switching signal is derived from the reference signal by frequency conversion.

20. The method as claimed in claim 15, wherein the laser-active medium is optically pumped in continuous-wave operation.
